(19) United States
(12) Patent Application Publication
(10) Pub. No.: US 2016/0338523 A1
(43) Pub. Date: Nov. 24, 2016

(54) DEVICE FOR PREPARING INFUSED DRINKS, COMPRISING A CAPSULE POSITIONING MEANS

(71) Applicant: TCONCEPT COMPANY S.P.R.L., Corroy-le-Grand (BE)

(72) Inventor: Luc VAN BELLEGHEM, (US)

(73) Assignee: TCONCEPT COMPANY S.P.R.L., Corroy-le-Grand (BE)

(21) Appl. No.: 14/901,254

(22) PCT Filed: Jun. 24, 2014
(86) PCT No.: PCT/EP2014/063298

§ 371 Date: Dec. 28, 2015

(30) Foreign Application Priority Data
Jun. 25, 2013 (BE) 2013/0436

(51) Int. Cl. A47J 31/36; A47J 31/40

(52) U.S. Cl. CPC A47J 31/3633; A47J 31/369; A47J 31/407

(57) ABSTRACT

The invention relates to a device comprising: a support arranged to receive a capsule provided with a front face, a ring, a rear face, and a casing and defining a container; injection means arranged to introduce an infusion liquid into the capsule; an infusion chamber having a substantially vertical opening arranged to be in fluid communication with a filter wall; and an outlet.

The present invention relates to a device for preparing infused drinks comprising:

a support arranged to receive a capsule containing a substance to be infused in the dry state provided with a front face comprising a filter wall, a ring surrounding said front face, a rear face, opposite said front face and a solid casing extending between said ring and said rear face and defining a container arranged to contain said substance to be infused, in a position wherein said front face is substantially vertical,

injection means arranged to introduce an infusion liquid into said capsule, when said support receives a capsule,

an infusion chamber having a substantially vertical opening, said substantially vertical opening being arranged to be in fluid communication with said filter wall, said ring comprising sealing means arranged to keep the fluid communication tight in relation to an ambient environment, outside a fluid exchange zone, and

an outlet provided with closing/opening means arranged to enable an infused liquid to flow from the infusion chamber.

Such a device or method is known for example from the document EP2112093. However, according to this document, the water is injected via the rear face of the capsule, thus requiring piercing thereof.

Unfortunately, rear piercing presents some problems in that the capsule frequently remains impaled on the tip and thus cannot be easily removed without human intervention, which in turn sometimes requires dismantling a part of the device or rendering the area wherein the capsule is located easily accessible. In any case, the use of the tip to pierce the rear face of the capsule involves some drawbacks both in terms of the design of the machine and that of the capsule.

The document WO 2012020343 discloses an infusion device comprising an infusion chamber which is subdivided into two parts. A first relatively immobile part on which the second part including a capsule to be infused is tightly mounted. The infusion chamber of such a device is formed when the first and second parts are in fluid communication.

Unfortunately, the infusion volume of such a device is limited by the volumetric infusion space of the capsule containing the substance to be infused.

From the document WO 2012025259, a device of the same type is known wherein a plunger comprising piercing means is described. This plunger is moved by a precision low-voltage motor when said motor is required to control the forward movement of the plunger to maintain tightness on one hand and, on the other, ensure perfect alignment of the plunger to enable the penetration of the rear face which needs to be perfectly transversal in relation to the rear face of the capsule.

Unfortunately, such a device requires the addition of a precision low-voltage motor which is costly and requires space, whereas the current trend is to provide compact devices at competitive prices.

The aim of the invention is that of remedying the drawbacks of the prior art by providing an invention making it possible to do away with a low-voltage motor and improve the production costs of the machine.

To solve this problem, the invention envisages a device as initially described wherein said means for injecting said infusion liquid reach the infusion chamber or the container of the capsule via an infusion liquid injection tube and comprising a cylinder (9) comprising a first end and a second end, said first end comprising at least one contact zone arranged to push said rear face of the capsule, and translation means arranged to create a horizontal relative translational movement between said cylinder and said infusion chamber so as to maintain the tightness between the capsule and said infusion chamber by a compression force applied onto said sealing means maintaining the fluid communication, said translation means are connected to said cylinder, said cylinder having a first retracted position and a second contact position, said translation means being arranged to move said cylinder between said first position and said second position, corresponding to a position wherein said capsule is in tight contact with said infusion chamber and where said compression force is applied onto said sealing means.

Simple translation means using the energy present or human energy are envisaged, without any additional device such as a low-voltage motor, making it possible to carry out a relative translation between the infusion chamber and a cylinder maintaining the tightness between the capsule and the infusion chamber to ensure fluid communication between the two.

Furthermore, in this way, the infusion liquid enters, by means of the injection tube, said infusion chamber via the top of the infusion chamber and flows so as to progressively fill the assembly consisting of the infusion chamber in fluid communication with said container defined by said solid casing extending between said ring and said rear face, wherein the substance to be infused is located. The capsule container is also progressively filled at the same rate as the infusion chamber. As such, the volumetric injection space consists of the infusion chamber and the capsule container.

In one alternative embodiment, the infusion liquid supplying the infusion chamber thus flows from the top to the bottom creating turbulence in a part of the infusion liquid already present thus forming turbulence in the infusion liquid contained in the infusion chamber for enhancing the homogeneity of the infusion liquid which becomes the infused liquid over time and mixing of this infusion liquid. Furthermore, this injection of injection liquid via the infusion chamber makes it possible to obtain a difference in temperature of the infusion liquid present in the infusion chamber and that present in the capsule container between 3 and 10° C. and typically approximately 5° C. This makes it possible to be able to reach an optimal temperature for the infusion in the capsule container, while keeping the infusion liquid in the infusion chamber at a slightly higher temperature, thus making it possible to serve an infused drink that is still sufficiently hot after the infusion time. Note that, during the infusion liquid injection phase, the newly injected infusion liquid heats the infusion liquid already present.

In a further alternative embodiment, said injection tube is extended by an elbow arranged to inject said infusion liquid via said front face of said capsule. In this way, the infusion liquid supplies the capsule container first and then the infusion chamber. The infusion liquid thus flows from the top to the bottom creating turbulence in a part of the infusion liquid already present in the capsule container thus forming turbulence in the infusion liquid for enhancing the homogeneity of the infusion liquid which becomes the infused liquid over time and mixing of this infusion liquid. Furthermore, this injection of injection liquid via the infusion chamber makes it possible to obtain a difference in temperature of the infusion liquid present in the infusion chamber and that present in the capsule container between 3 and 10° C. and typically approximately 5° C. This makes it possible to be able to reach an optimal temperature for the infusion in the capsule container, while keeping the infusion liquid in the infusion chamber at a slightly lower temperature, thus making it possible to serve an infused drink that is still sufficiently hot after the infusion time. Note that, during the infusion liquid injection phase, the newly injected infusion liquid heats the infusion liquid already present.

In one particular embodiment, said translation means are controlled manually by a handle having an idle position and an activation position where, when said handle is in the idle position, said cylinder is in the retracted position and when said handle is in the activation position, said cylinder is in the contact position.

Preferably, the invention relates to a device wherein said translation means are controlled hydraulically by said injection means.

Advantageously, the device according to the present invention further comprises a second cylinder, arranged concentrically with said cylinder, connected to said translation means or integral with said translation means.

Preferably, said cylinder has a bearing zone arranged to apply a force on a rear face of said ring, situated opposite the front face of the capsule and to apply compression of the sealing means to keep the fluid communication tight in relation to said ambient environment.

Advantageously, said second cylinder, concentric with said cylinder, applies a pressure on said rear face of said capsule making it possible to apply compression of the sealing means to keep the fluid communication tight in relation to said ambient environment.

In one preferential embodiment, said compression force applied to said sealing means is an active force.

In one alternative embodiment of the present invention, said translation means are connected to said infusion chamber, said infusion chamber having a first retracted position and a second contact position, said translation means being arranged to move said infusion chamber between said first position and said second position, corresponding to a position wherein said capsule is in tight contact with said infusion chamber and where said compression force is applied onto said sealing means.

In one particularly advantageous embodiment of the device according to the invention, said translation means are controlled manually by a handle having an idle position and an activation position where, when said handle is in the idle position, said infusion chamber is in the retracted position and when said handle is in the activation position, said infusion chamber is in the contact position.

Furthermore, in one particular embodiment, said translation means are controlled hydraulically by said injection means.

Advantageously, the device according to the present invention further comprises a second cylinder, arranged concentrically with said cylinder.

Preferentially, said cylinder has a bearing zone arranged to apply a force on a rear face of said ring, situated opposite the front face of the capsule and to apply compression of the sealing means to keep the fluid communication tight in relation to said ambient environment.

In a further preferred embodiment according to the present invention, said second cylinder, concentric with said cylinder, applies a pressure on said rear face of said capsule making it possible to apply compression of the sealing means to keep the fluid communication tight in relation to said ambient environment.

Preferentially, said compression force applied to said sealing means is a reactive force.

Advantageously, said translation means are connected to said cylinder and to said infusion chamber, said cylinder and said infusion chamber having a first retracted position and a second contact position, said translation means being arranged to move said infusion chamber and said cylinder between said first position and said second position, corresponding to a position wherein said capsule is in tight contact with said infusion chamber and where said compression force is applied onto said sealing means.

In one particularly preferred embodiment of the present invention, the device comprises detection means arranged to read information lodged on said rear face of said capsule, said detection means being at least partially confined in said cylinder or said second cylinder.

Indeed, insofar as, according to the present invention, the cylinder no longer needs to comprise means for piercing the rear face of the capsule, it can then accommodate detection means while protecting same from the machine environment, for example from light to ensure accurate and effective information detection. This information will advantageously contain parameters in respect of the temperature, pressure and quantity (volume) of the infusion liquid to be envisaged and applied along with information in respect to the duration of the infusion step. The detection means then generate a signal transmitted to auxiliary control means such as a pressure, temperature, and volume regulator for adjusting these parameters and to the means for controlling the opening for draining infused liquid, thus making it possible to obtain a perfect infused drink regardless of the nature of the dry substance to be infused under all circumstances, each substance to be infused having different predefined infusion conditions (temperature, pressure, time and volume) in the machine set-up to enable said optimal infusion.

Preferably, said detection means are bar code, color, pictogram, tag and similar detection means.

Advantageously, said infusion chamber is at least partially formed of a polyfluoride-based material, such as for example PTFE, FEP, or PFA.

Advantageously, said capsule support is a seat having a significantly open structure.

More preferentially, said infusion liquid injection tube is connected to an upper part of said infusion chamber in the vicinity of said substantially vertical opening.

Furthermore, the device according to the present invention comprises cleaning means arranged to introduce a rinsing liquid into said infusion chamber.

Similarly, the device according to the present invention further comprises means for heating said infusion liquid.

Preferably, the device according to the present invention further comprises a container of infusion liquid, connected to or comprising said means for heating said infusion liquid.

Advantageously, the device according to the present invention further comprises a pump connected on one hand to said infusion liquid injection tube and to a supply of infusion liquid, optionally in the form of said container of infusion liquid.

In one alternative embodiment according to the invention, the device according to the invention comprises a pump connected on one hand to said infusion liquid injection tube and to a supply of infusion liquid, connected to said device for heating said infusion liquid.

Preferably, the device according to the invention further comprises a pressure regulating device, connected to said infusion liquid injection tube and to a supply of infusion liquid, optionally upstream or downstream from said pump, if present.

The present invention also relates to a device wherein said pump is also connected to said translation means.

In one preferred embodiment, said infusion liquid injection tube has a rectilinear zone, wherein one end is connected to said infusion chamber, said rectilinear zone being substantially vertical.

In one advantageous alternative embodiment of the invention, said rectilinear zone of said infusion liquid injection tube is at least partially formed of a polyfluoride-based material, such as for example PTFE, FEP, or PFA.

Preferably, said rectilinear zone of said infusion liquid injection tube is for example obtained by simultaneous molding of said infusion chamber and said rectilinear zone.

Further embodiments of the device according to the invention are described in the appended claims.

The invention also relates to a method for preparing infused drinks, comprising the following steps:

introducing a capsule containing a substance to be infused in the dry state provided with a front face comprising a filter wall, a ring surrounding said front face, a rear face, opposite said front face and a solid casing extending between said ring and said rear face and defining a container arranged to contain said substance to be infused, in a position wherein said front face is substantially vertical, onto a capsule support,

injecting an infusion liquid into said container of said capsule,

infusing said infusion liquid with said dry substance to be infused so as to form said infused drink in said infusion chamber in fluid communication with the capsule container, and

draining said infused liquid via an opening located in the bottom of said infusion chamber after said infusion step.

This method is characterized in that it further comprises a relative translational movement between a cylinder and said infusion chamber to maintain tightness between said capsule and said infusion chamber of said fluid communication, said cylinder comprising a first end and a second end, said first end comprising at least one contact zone arranged to push said rear face of the capsule, and translation means arranged to create a horizontal relative translational movement between said cylinder and said infusion chamber so as to maintain the tightness between the capsule and said infusion chamber by a compression force applied onto said sealing means maintaining the fluid communication.

Advantageously, said translational movement is a translational movement of the cylinder.

In one alternative embodiment, said translational movement is a translational movement of said infusion chamber.

In a further alternative embodiment, said translational movement is a translational movement of the cylinder and the infusion chamber.

Preferably, the method according to the invention further comprises detection of information lodged on said rear face of said capsule, said detection means being at least partially confined in said cylinder.

Preferably, said detection is bar code, color, pictogram, tag and similar detection.

Advantageously, the detection of said information generates a signal, said signal being transmitted to control means, said control means subsequently acting upon auxiliary temperature, infusion time, infusion liquid pressure and infusion liquid quantity control means, so as to act upon the temperature and/or volume and/or pressure and on the infusion time of said infusion liquid, based on the information.

Preferably, said injection of an infusion liquid into said container of said capsule takes place by injecting said infusion liquid in the infusion chamber in fluid communication with said container of said capsule, said infusion liquid flowing into the infusion chamber percolating through said filter wall to enter said capsule container.

Preferentially, a part of the infusion step takes place simultaneously with said injection step.

Particularly preferentially, said injection of said infusion liquid is carried out from top to bottom and causes turbulence in the infusion liquid already present in the infusion chamber, so as to homogenize the contents of the infusion liquid.

Advantageously, the method according to the invention further comprises a cleaning step wherein a rinsing fluid is introduced into and drained from the infusion chamber.

In particular, the method also comprises a step for removing the capsule from the support thereof after draining said infused liquid from the infusion chamber.

Further embodiments of the method according to the invention are described in the appended claims.

Further features, details and advantages of the invention will emerge from the description given hereinafter, for non-limiting purposes and with reference to the appended figures.

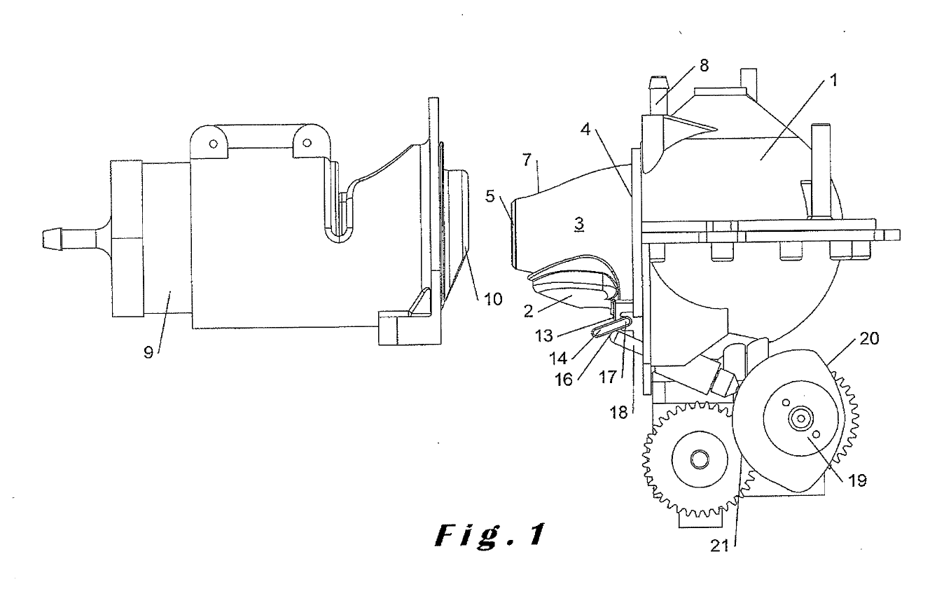

FIG. 1 is a schematic view of a device according to the present invention.

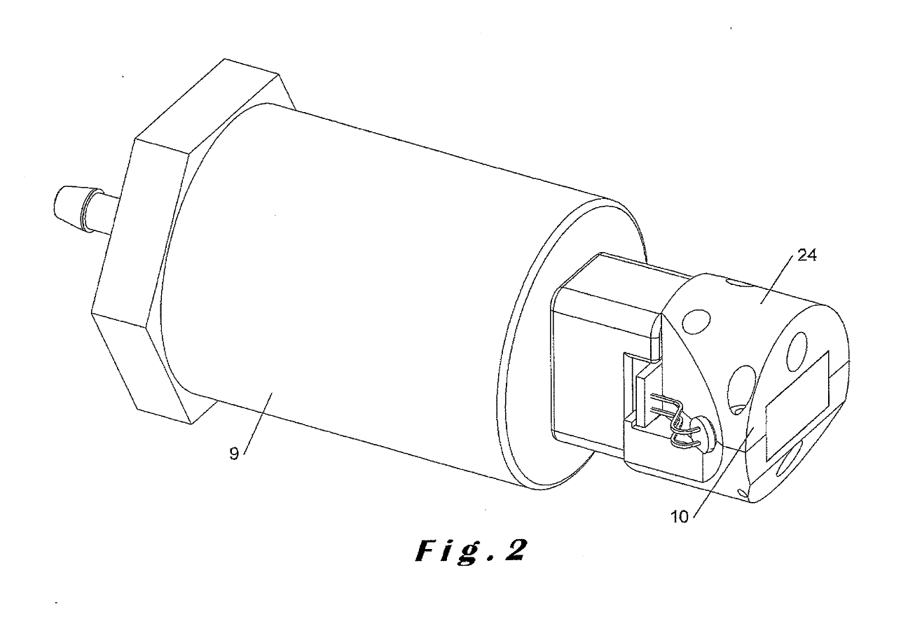

FIG. 2 is a schematic view of a cylinder provided with detection means according to the present invention.

In the figures, identical or equivalent elements bear the same references.

As can be seen in the figure, one aspect of the present invention relates to a device intended to receive a capsule (3) of ingredients and extract the ingredient by injecting liquid into a capsule (3) and into and via an infusion chamber.

The capsule (3) will be positioned between two parts. The two parts are arranged so as to be movable in relation to one another from an open position—for inserting of removing a capsule (3)—to a closing position—to pass a heated liquid in the capsule (3).

Advantageously, in the embodiment illustrated, at least one of the movable parts is hydraulically actuated and movable into the closed position by the liquid injection device.

As a general rule, this device consists of a machine for preparing drinks for receiving ingredient capsules (3). For example, the machine is a machine for preparing coffee, tea, chocolate or soup. In particular, the apparatus is arranged for preparing inside an infusion chamber (1) by passing hot water or another liquid inside a capsule (3) containing an ingredient of the drink to be prepared, such as ground coffee or tea or chocolate or cocoa or milk powder.

For example, the preparation machine comprises: a unit for preparing drinks arranged to receive capsules (3) for use and for removing the capsules (3) during use, for example, a device having an opening into a zone to which the capsules (3) are removed from the preparation unit, and a receptacle having a cavity forming a storage space to collect the capsules (3) removed to a region in the receptacle at a filling level. The receptacle may be inserted into the zone for collecting used capsules (3) and may be removed from this region to empty the capsules (3) collected.

More particularly, the device for preparing infused drinks comprises a support (2) arranged to receive a capsule (3) containing a substance to be infused in the dry state provided with a front face comprising a filter wall, a ring surrounding said front face, a rear face, opposite said front face and a solid casing extending between said ring and said rear face and defining a container arranged to contain said substance to be infused, in a position wherein said front face is substantially vertical.

Advantageously, the present invention makes it possible to maintain tightness between the capsule (3) and the infusion chamber (1) when a hydraulic loss or a reduction in tightness occurs. The increase in the hydraulic pressure in the plunger makes it possible compensate for this decrease in fluid tightness. One alternative also suitable for compensating for any reduction in tightness between the capsule and the infusion chamber may also be the use of a plunger provided with a spring such that the plunger maintains sufficient pressure on the capsule so as to retain the fluid tightness.

The device also comprises injection means arranged to introduce an infusion liquid into said capsule (3), when said support (2) receives a capsule (3), and an infusion chamber (1) having a substantially vertical opening, said substantially vertical opening being arranged to be in fluid communication with said filter wall, said ring comprising sealing means arranged to keep the fluid communication tight in relation to an ambient environment, outside a fluid exchange zone, and an outlet provided with closing/opening means arranged to enable an infused liquid to flow from the infusion chamber (1).

As can be seen, the means for injecting said infusion liquid reach the infusion chamber (1) via an infusion liquid injection tube.

The device according to the invention comprises a cylinder comprising a first end and a second end, said first end comprising at least one hollow receiving zone arranged to house said rear face of the capsule (3) and said solid casing, and translation means arranged to create a horizontal relative translational movement between said cylinder and said infusion chamber (1) so as to maintain the tightness between the capsule (3) and said infusion chamber (1) by a compression force applied onto said sealing means maintaining the fluid communication.

According to the invention, the device is configured so as to pressurize and circulate unheated liquid to at least one support (2) intended to actuate and move at least one support (2) by circulating unheated pressurized liquid.

Typically, the translation means, preferably hydraulic suitable for actuation and movable, has a linear movement configuration.

In one embodiment, it comprises a hydraulic plunger formed from a cylinder (9) and a second concentric cylinder, such as a plunger, movable in a plunger chamber, the liquid injection device being connected to the plunger chamber for injecting pressurized liquid into the chamber and the hydraulic control of the pressure of the plunger against the capsule (3) creates the closed position.

For example, the plunger chamber has an inlet and an outlet to circulate a pressurized liquid via the plunger chamber. It consists of a single liquid circulation device for the hydraulic closure of the seat of the capsule (3) and holding same in a closed state, and for extracting the substance from the capsule (3). However, hydraulic closure and holding the seat in a closed state are carried out with an unheated circulating liquid whereas extraction is performed with the liquid during heating.

In a further embodiment, the hydraulic plunger closes a second chamber having a spring. This spring chamber makes it possible to apply pressure on the plunger chamber.

Typically, when the hydraulic outlet of the chamber enables the liquid to flow outside the plunger chamber, at least one spring included in the spring chamber will make it possible to accelerate this draining of the plunger chamber and create the open position of the seat of the capsule (3).

Advantageously, this open position will be held by means of the force of at least one spring, without any hydraulic pressure being activated in the device.

The plunger chamber typically has an inlet and an outlet to circulate pressurized liquid via the plunger chamber, whereas the supports are capsules in the closing position.

Typically, the device is associated with a pump and circulates a liquid in the capsule (3) by means of the hydraulic support, for example, via the plunger chamber.

At least one of the capsule (3) supports may be moved towards and away from the support of the capsule (3) facing same by a mechanical drive device. The mechanical drive device may comprise a force transmission lever, in particular a hinge arrangement, and/or a force transmission gear arrangement, in particular a spur pinion arrangement. The mechanical drive device may be actuated by a handle suitable for being driven by hand and/or by a motor, in particular an electric motor.

Device wherein the plunger is associated with a system for reading the recognition code (24) of the capsule (3). Typically, the device is suitable for receiving capsules (3) having substances to be infused requiring varied infusion parameters. The term parameters denotes for example the temperature of the liquid injected into the capsule (3), the infusion time of the substance contained in the capsule (3), the injection cycle(s) of liquid into the capsule (3).

Advantageously, the precision of the plunger travel and the linearity of the movement make it possible to facilitate the reading precision of the recognition system (24) placed on the face of the capsule (3) in contact with the reader. The term recognition code denotes a color code, a bar code, a logo, pictogram, QR code, etc.

Obviously, the present invention is in no way limited to the embodiments described above and many modifications may be made thereto without leaving the scope of the appended claims.

1. Device for preparing infused drinks comprising:
a support arranged to receive a capsule containing a substance to be infused in the dry state provided with a front face comprising a filter wall, a ring surrounding said front face, a rear face, opposite said front face and a solid casing extending between said ring and said rear face and defining a container arranged to contain said substance to be infused, in a position wherein said front face is substantially vertical,
injection means arranged to introduce an infusion liquid into said capsule, when said support receives a capsule,
an infusion chamber having a substantially vertical opening, said substantially vertical opening being arranged to be in fluid communication with said filter wall, said ring comprising sealing means arranged to keep the fluid communication tight in relation to an ambient environment, outside a fluid exchange zone, and
an outlet provided with closing/opening means arranged to enable an infused liquid to flow from the infusion chamber,
wherein said means for injecting said infusion liquid reach the infusion chamber via an infusion liquid injection tube and in that it further comprises a cylinder comprising a first end and a second end, said first end comprising at least one hollow receiving zone arranged to house said rear face of the capsule and said solid casing, and translation means arranged to create a horizontal relative translational movement between said plunger and said infusion chamber so as to maintain the tightness between the capsule and said infusion chamber by a compression force applied onto said sealing means maintaining the fluid communication.

2. Device according to claim 1, wherein said translation means are connected to said cylinder, said cylinder having a first retracted position and a second contact position, said translation means being arranged to move said cylinder between said first position and said second position, corresponding to a position wherein said capsule is in tight contact with said infusion chamber and where said compression force is applied onto said sealing means.

3. Device according to claim 2, wherein said translation means are controlled manually by a handle having an idle position and an activation position where, when said handle is in the idle position, said cylinder is in the retracted position and when said handle is in the activation position, said cylinder is in the contact position.

4. Device according to claim 2, wherein said translation means are controlled hydraulically by said injection means.

5. Device according to claim 1, further comprising a second cylinder, arranged concentrically with said cylinder, connected to said translation means or integral with said translation means.

6. Device according to claim 1, wherein said cylinder has a bearing zone arranged to apply a force on a rear face of said ring, situated opposite the front face of the capsule and to apply compression of the sealing means to keep the fluid communication tight in relation to said ambient environment.

7. Device according to claim 1, wherein said second cylinder, concentric with said cylinder, applies a pressure on said rear face of said capsule making it possible to apply compression of the sealing means to keep the fluid communication tight in relation to said ambient environment.

8. Device according to claim 1, wherein said compression force applied to said sealing means is an active force.

9. Device according to claim 1, wherein said translation means are connected to said infusion chamber, said infusion chamber having a first retracted position and a second contact position, said translation means being arranged to move said infusion chamber between said first position and said second position, corresponding to a position wherein said capsule is in tight contact with said infusion chamber and where said compression force is applied onto said sealing means.

10. Device according to claim 9, wherein said translation means are controlled manually by a handle having an idle position and an activation position where, when said handle is in the idle position, said infusion chamber is in the retracted position and when said handle is in the activation position, said infusion chamber is in the contact position.

11. Device according to claim 9, wherein said translation means are controlled hydraulically by said injection means.

12. Device according to claim 9, further comprising a second cylinder, arranged concentrically with said cylinder.

13. Device according to claim 9, wherein said cylinder has a bearing zone arranged to apply a force on a rear face of said ring, situated opposite the front face of the capsule and to apply compression of the sealing means to keep the fluid communication tight in relation to said ambient environment.

14. Device according to claim 9, wherein said second cylinder, concentric with said cylinder, applies a pressure on said rear face of said capsule making it possible to apply compression of the sealing means to keep the fluid communication tight in relation to said ambient environment.

15. Device according to claim 9, wherein said compression force applied to said sealing means is a reactive force.

16. Device according to claim 9, wherein said translation means are connected to said cylinder and to said infusion chamber, said cylinder and said infusion chamber each having a first retracted position and a second contact position, said translation means being arranged to move said infusion chamber and said cylinder between said first position and said second position, corresponding to a position wherein said capsule is in tight contact with said infusion chamber and where said compression force is applied onto said sealing means.

17. Device according to claim 1, comprising detection means arranged to read information lodged on said rear face of said capsule, said detection means being at least partially confined in said cylinder or said second cylinder.

18. Device according to claim 17, wherein said detection means are bar code, color, pictogram, tag and similar detection means.

19. Device according to claim 1, wherein said infusion chamber is at least partially formed of a polyfluoride-based material, such as for example PTFE, FEP, or PFA.

20. Device according to claim 19, wherein said capsule support is a seat having a significantly open structure.

21. Device according to claim 1, wherein said infusion liquid injection tube is connected to an upper part of said infusion chamber in the vicinity of said substantially vertical opening.

22. Device according to claim 1, further comprising cleaning means arranged to introduce a rinsing liquid into said infusion chamber.

23. Device according to claim 1, comprising means for heating said infusion liquid.

24. Device according to claim 23, further comprising, a container of infusion liquid, connected to or comprising said means for heating said infusion liquid.

25. Device according to claim 1, further comprising a pump connected on one hand to said infusion liquid injection tube and to a supply of infusion liquid, optionally in the form of said container of infusion liquid.

26. Device according to claim 1, further comprising a pump connected on one hand to said infusion liquid injection tube and to a supply of infusion liquid, connected to said device for heating said infusion liquid.

27. Device according to claim 1, further comprising a pressure regulating device, connected to said infusion liquid injection tube and to a supply of infusion liquid, optionally upstream or downstream from said pump, if present.

28. Device according to claim 25, when it is dependent on claims 4 and/or 11, wherein said pump is also connected to said translation means.

29. Device according to claim 1, wherein said infusion liquid injection tube has a rectilinear zone, wherein one end if connected to said infusion chamber, said rectilinear zone being substantially vertical.

30. Device according to claim 29, wherein said rectilinear zone of said infusion liquid injection tube is at least partially formed of a polyfluoride-based material, such as for example PTFE, FEP, or PFA.

31. Device according to claim 30, wherein said rectilinear zone of said infusion liquid injection tube rigidly connected to said infusion chamber and is for example obtained by simultaneous molding of said infusion chamber and said rectilinear zone.

32. Device according to claim 1, wherein said infusion chamber comprises an apex through which pass a first horizontal top tangent plane and a median plane separating the infusion chamber into two parts wherein a first part comprises said substantially vertical opening, said substantially vertical opening also having an apex through which a second horizontal tangent plane passes, parallel with said first horizontal top tangent plane, said injection tube of said infusion liquid being connected to said infusion chamber via an infusion liquid passage opening through an external wall of said infusion chamber, said infusion liquid passage opening being situated between the first and the second tangent planes and in said first part.

33. Method for preparing infused drinks, comprising the following steps:
introducing a capsule containing a substance to be infused in the dry state provided with a front face comprising a filter wall, a ring surrounding said front face, a rear face, opposite said front face and a solid casing extending between said ring and said rear face and defining a container arranged to contain said substance to be infused, in a position wherein said front face is substantially vertical, onto a capsule support,
injecting an infusion liquid into said container of said capsule,
infusion of said infusion liquid with said dry substance to be infused so as to form said infused drink in said infusion chamber in fluid communication with the capsule container, and
draining said infused liquid via an opening located in the bottom of said infusion chamber after said infusion step,
wherein said injection of the infusion liquid into said container of said capsule is performed via the infusion chamber, said injection being performed in said infusion chamber, and in that it further comprises a relative translational movement between a cylinder and said infusion chamber to maintain tightness between said capsule and said infusion chamber of said fluid communication, said cylinder comprising a first end and a second end, said first end comprising at least one hollow receiving zone arranged to house said rear face of the capsule and said solid casing, and translation means arranged to create a horizontal relative translational movement between said plunger and said infusion chamber so as to maintain the tightness between the capsule and said infusion chamber by a compression force applied onto said sealing means maintaining the fluid communication.

34. Method according to claim 33, wherein said translational movement is a translational movement of said cylinder.

35. Method according to claim 33, wherein said translational movement is a translational movement of said infusion chamber.

36. Method according to claim 33, wherein said translational movement is a translational movement of the cylinder and the infusion chamber.

37. Method according to claim 33, further comprising detection of information lodged on said rear face of said capsule, said detection means being at least partially confined in said cylinder.

38. Method according to claim 37, wherein said detection is bar code, color, pictogram, tag and similar detection.

39. Method according to claim 37, wherein the detection of said information generates a signal, said signal being transmitted to control means, said control means subsequently acting upon auxiliary temperature, infusion time, infusion liquid pressure and infusion liquid quantity control means, so as to act upon the temperature and/or volume and/or pressure and on the infusion time of said infusion liquid, based on the information.

40. Method according to claim 33, wherein said injection of an infusion liquid into said container of said capsule takes place by injecting said infusion liquid in the infusion chamber in fluid communication with said container of said capsule, said infusion liquid flowing into the infusion chamber percolating through said filter wall to enter said capsule container.

41. Method according to claim 40, wherein a part of the infusion step takes place simultaneously with said injection step.

42. Method according to claim 40, wherein said injection of said infusion liquid is carried out from top to bottom and causes turbulence in the infusion liquid already present in the infusion chamber, so as to homogenize the contents of the infusion liquid.

43. Method according to claim 33, further comprising a cleaning step wherein a rinsing fluid is introduced into and drained from the infusion chamber.

44. Method according to claim 33, further comprising a step for removing the capsule from the support thereof after draining said infused liquid from the infusion chamber.
